(19) United States
(12) Patent Application Publication
(10) Pub. No.: US 2026/0244061 A1
(43) Pub. Date: Aug. 20, 2026

(54) ELECTROLYTE-ELECTRODE STACK AND METHODS FOR PRODUCING THEREOF

(71) Applicant: Tynt Technologies, Inc., Boulder, CO (US)

(72) Inventors: Tyler Steven Hernandez, Boulder, CO (US); David Allen Brewster, Commerce City, CO (US); Matthew Kent McBride, Boulder, CO (US); Sarah Elizabeth Livingston, Golden, CO (US); Laura Lynn Schoeneman, Thorton, CO (US); Tawney Ann Knecht, Wheat Ridge, CO (US); Ameen Khalil Saafir, Broomfield, CO (US)

(73) Assignee: Tynt Technologies, Inc., Boulder, CO (US)

(21) Appl. No.: 19/461,279

(22) Filed: Jan. 27, 2026

Related U.S. Application Data
(60) Provisional application No. 63/750,175, filed on Jan. 27, 2025.

(51) Int. Cl. G02F 1/1506; G02F 1/1523; G02F 1/153; G02F 1/155

(52) U.S. Cl. CPC G02F 1/1506; G02F 1/1525; G02F 1/1533; G02F 1/155; G02F 2001/1536

(57) ABSTRACT

The present disclosure relates to electrolyte-electrode stacks useful for dynamic reversible metal electrodeposition (RME) applications. The disclosed stack comprises a thin polymeric film substrate with a patterned metallic electrode disposed on it and a gel polymer electrolyte (GPE) layer in contact with the electrode. The stack can be manufactured through continuous roll-to-roll (R2R) processes, enabling efficient large-scale production. The stack may be stored in rolled form and applied as a single prefabricated component, simplifying device assembly and reducing manufacturing complexity.

### CROSS-REFERENCE TO RELATED APPLICATIONS

This application claims priority to U.S. Provisional Patent Application No. 63/750,175, filed Jan. 27, 2025, the content of which is incorporated herein by reference in its entirety.

### FIELD

The present disclosure relates to the field of electrochemical devices and materials. More specifically, it relates to the manufacturing of electrolyte-electrode stacks useful in applications such as reversible metal electrodeposition (RME) in insulated glass lines and other optical and electrochemical applications.

### BACKGROUND

The development of efficient and scalable methods for manufacturing electrolyte-electrode structures is crucial for advancing various electrochemical technologies. Traditional methods often involve complex and time-consuming processes that are not suitable for large-scale production. Existing technologies struggle with limitations such as material specificity, mechanical stability, and scalability.

Therefore, there exists a need for improved compositions and methods for producing electrolyte-electrode structures having desirable mechanical and viscoelastic properties for durable and efficient RME and other applications.

### BRIEF SUMMARY

Accordingly, the present disclosure addresses this need by providing an electrolyte-electrode stack comprising a polymeric film substrate, a patterned metallic electrode disposed on the polymeric film substrate, and a gel polymer electrolyte (GPE) film in contact with the patterned metallic electrode.

The present disclosure also provides methods for producing the electrolyte-electrode stack, such as by using roll-to-roll (R2R) calendaring processes to facilitate integration into existing manufacturing facilities for efficient and scalable production. In one aspect, the method comprises: providing a patterned metallic electrode disposed on a polymeric film substrate, applying the patterned metallic electrode on the polymeric film substrate onto a GPE film using a calendaring process. The method may further comprise applying a release liner to the GPE film to form a single adherence stack to preserve shelf-life and for easy storage and transport. The method may further comprise removing the release liner and applying the single adherence stack to a transparent conducting oxide (TCO) layer on a glass or plastic surface.

In another aspect, the present disclosure provides a method for improving the mechanical stability of a GPE film, comprising: providing a patterned metallic electrode disposed on a polymeric film substrate, applying the patterned metallic electrode on the polymeric film substrate onto the GPE film using a calendaring process. The method may further comprise laminating the GPE film with a release liner. The patterned metallic electrode provides structural reinforcement to the GPE, enabling the GPE to be handled and processed in roll-to-roll manufacturing systems.

In yet another aspect, provided herein is a method for preparing a GPE film by mechanical or high shear mixing of a polymer and an electrolyte plasticizer.

The polymeric film substrate of the disclosure may comprise one or more materials selected from polyvinyl butyral (PVB), acrylate polymer, silicone, rubber, polyethylene terephthalate (PET), ethylene-vinyl acetate (EVA), triacetate cellulose (TAC), cyclic olefin polymer (COP), polycarbonate (PC), and optically clear adhesive (OCA). The polymeric film substrate may be capable of adhering to a glass or plastic surface, enabling direct application to transparent conducting oxide (TCO) coated substrates.

The patterned metallic electrode disclosed herein may comprise one or more metals selected from bismuth, zinc, copper, aluminum, silver, gold, nickel, and oxides thereof. Metal oxides may include bismuth oxide (Bi₂O₂), zinc oxide (ZnO), copper oxide (CuO, Cu₂O), aluminum oxide (Al₂O₃), silver oxide (Ag₂O), and nickel oxide (NiO). The patterned structure may comprise a mesh, grid, or network configuration that provides electrical conductivity while maintaining optical transparency. The patterned metallic electrode may be configured to enable reversible metal electrodeposition (RME), wherein application of electrical voltage causes metal to deposit or dissolve, thereby modulating optical transmission.

The gel polymer electrolyte (GPE) film may comprise one or more polymers selected from poly(methyl methacrylate) (PMMA), poly(acrylonitrile), poly(vinyl alcohol), poly(vinyl acetate), poly(vinyl butyrate), polymers soluble in polar organic solvents or solvent mixtures, and copolymers thereof. The polymers may be linear, branched, cross-linked, or non-cross-linked. The GPE film may be in contact with the patterned metallic electrode, enabling ion transport for electrochemical reactions.

The electrolyte-electrode stack may further comprise a release liner adjacent to the GPE film. Release liners may be provided on both outer surfaces of the stack, enabling the stack to be wound into a roll configuration for storage and transport. The release liners may be removed prior to application of the stack to a substrate.

In an alternative embodiment, the electrolyte-electrode stack may further comprise a transparent conducting oxide (TCO) layer in contact with a surface of the GPE film opposite the patterned metallic electrode. The TCO layer may comprise indium tin oxide (ITO), fluorine-doped tin oxide (FTO), aluminum-doped zinc oxide (AZO), or other suitable materials. This integrated configuration may provide a complete electrochemical device in a single roll-to-roll manufactured product.

The present disclosure also provides methods for producing the electrolyte-electrode stack. The method may comprise providing a patterned metallic electrode disposed on a polymeric film substrate, applying the patterned metallic electrode on the polymeric film substrate onto a GPE film using a calendaring process, applying a release liner to the GPE film to form a single adherence stack, and optionally removing the release liner and applying the single adherence stack to a TCO layer on a glass or plastic surface.

The calendaring process may comprise extruding the GPE film to a predetermined thickness, flattening the patterned metallic electrode on the polymeric film, and applying the patterned metallic electrode on the polymeric film substrate onto the GPE film by applying pressure and heat. The calendaring process may comprise heating the GPE film to a temperature, e.g., between 20° C. and 150° C., to enhance pliability. The patterned metallic electrode on the polymeric film substrate may be flattened against a release liner before applying to the GPE film.

In another aspect, the present disclosure provides a method for improving the mechanical stability of a GPE film. The method may comprise providing a patterned metallic electrode disposed on a polymeric film substrate, applying the patterned metallic electrode on the polymeric film substrate onto the GPE film using a calendaring process, and laminating the GPE film with a release liner. The patterned metallic electrode may provide structural reinforcement to the GPE, enabling the GPE to be handled and processed in roll-to-roll manufacturing systems.

In yet another aspect, the disclosure provides a method comprising preparing a GPE film by mechanical or high shear mixing of a polymer and an electrolyte plasticizer. The polymer may be selected from poly(methyl methacrylate) (PMMA), poly(acrylonitrile), poly(vinyl alcohol), poly(vinyl acetate), poly(vinyl butyrate), a polymer soluble in polar organic solvent or solvent mixture, a copolymer thereof, and any combination thereof, wherein the polymer may be linear, branched, cross-linked, or non-cross-linked. The electrolyte plasticizer may comprise a compatible solvent, an active metal salt, a supporting salt, a UV/oxidative stabilizer, and/or a surfactant. The method may further comprise removing the release liner and applying the electrolyte-electrode stack to a TCO layer on a glass or plastic surface for use in dynamic reversible metal electrodeposition (RME) applications.

The electrolyte-electrode stack may find utility in smart windows, anti-glare mirrors, adaptive displays, and other devices requiring controllable optical properties. The roll-to-roll manufacturing approach enables cost-effective production, while integration with patterned metallic electrodes provides mechanical stability to gel polymer electrolytes, enabling handling and processing previously thought impractical for continuous manufacturing.

### BRIEF DESCRIPTION OF THE DRAWINGS

FIG. 1 depicts the exemplary three main stages of the manufacturing process: Line 1, Line 2, and the Final Product Line.

FIG. 2 depicts an exemplary product of Line 2, with insets zooming in on the embedded patterned metallic electrode in a semi-rigid polymeric film.

### DETAILED DESCRIPTION

The following description is presented to enable a person of ordinary skill in the art to make and use the various embodiments. Descriptions of specific devices, techniques, and applications are provided only as examples. Various modifications to the examples described herein may be readily apparent to those of ordinary skill in the art, and the general principles defined herein may be applied to other examples and applications without departing from the spirit and scope of the various embodiments. Thus, the various embodiments are not intended to be limited to the examples described herein and shown but are to be accorded the scope consistent with the claims.

The present disclosure arises from the surprising discovery that gel polymer electrolytes (GPEs), which are typically thought to be difficult to handle due to their lack of dimensional stability, can be successfully manufactured and handled in roll-to-roll format when integrated with a patterned metallic electrode disposed on a polymeric film substrate. Conventional wisdom in the field suggested that the gel-like consistency of GPEs would preclude roll-to-roll processing, as the material would be expected to deform, tear, or flow under mechanical stress. However, the inventors unexpectedly found that calendaring a patterned metallic electrode on a polymeric film substrate together with the GPE creates a structure with sufficient mechanical integrity to be processed, stored, and handled in roll form. This discovery enables a manufacturing approach wherein prefabricated electrolyte-electrode stacks can be manufactured in continuous roll-to-roll format, stored with protective release liners, and applied directly to existing transparent conducting oxide coated glass or plastic surfaces at window assembly lines—providing a single source delivery system that eliminates the need for custom equipment or complex batch processing. The advantages include, e.g., enabling roll-to-roll manufacturing of GPE-based structures previously thought impractical, providing mechanical stability to GPE materials while maintaining their beneficial electrochemical properties, reducing manufacturing cost and complexity, enabling compact storage and transport, and providing versatile application to both glass and plastic substrates for smart windows, displays, and other electrochemical devices.

Accordingly, in one aspect, the present disclosure provides an electrolyte-electrode stack comprising: a polymeric film substrate, a patterned metallic electrode disposed on the polymeric film substrate, and a gel polymer electrolyte (GPE) film in contact with the patterned metallic electrode.

The polymeric film substrate may comprise one or more materials selected from polyvinyl butyral (PVB), acrylate polymer, silicone, rubber, polyethylene terephthalate (PET), ethylene-vinyl acetate (EVA), triacetate cellulose (TAC), cyclic olefin polymer (COP), polycarbonate (PC), and optically clear adhesive (OCA). The polymeric film substrate may be capable of adhering to a glass or plastic surface, enabling direct application to transparent conducting oxide (TCO) coated substrates.

The patterned metallic electrode may comprise one or more conductive metals or metal oxides suitable for reversible metal electrodeposition (RME) in electrochemical devices, wherein application of electrical voltage causes metal to deposit or dissolve, thereby modulating optical transmission.. Suitable metals include, but are not limited to, bismuth, zinc, copper, aluminum, silver, gold, nickel, and combinations thereof. The selection of metal is based on factors including electrochemical properties, optical absorption characteristics, deposition/dissolution kinetics, stability in the electrolyte environment, and cost. Bismuth and zinc are particularly advantageous metals for reversible metal electrodeposition applications due to their favorable electrochemical properties, including appropriate reduction potentials, good reversibility, and suitable deposition morphologies that provide effective optical modulation.

In some embodiments, the patterned metallic electrode comprises metal oxides of these metals, including bismuth oxide (Bi₂O₃), zinc oxide (ZnO), copper oxide (CuO, Cu₂O), aluminum oxide (Al₂O₃), silver oxide (Ag₂O), nickel oxide (NiO), and combinations thereof. Metal oxides provide advantageous optical properties, including reduced visible light absorption compared to metallic forms, while maintaining sufficient electrical conductivity for electrochemical device operation. The use of metal oxides can also enhance the durability and cycling stability of the electrochemical device by providing improved resistance to corrosion and degradation. For example, zinc oxide may provide high optical transparency in the visible spectrum while maintaining adequate conductivity, and bismuth oxide may offer favorable electrochemical properties for reversible metal electrodeposition reactions.

The metal or metal oxide may be formed into a patterned structure such as a mesh, grid, network, or other patterned configuration that provides electrical conductivity while maintaining optical transparency through the openings in the pattern. Typical pattern dimensions include line widths from 1 to 100 micrometers and spacings from 10 to 1000 micrometers, selected to balance optical transparency (typically 60-90% visible light transmission) with electrical conductivity (typically 1-100 ohms per square sheet resistance). The patterned metallic electrode may be formed by various methods including photolithography and etching, screen printing, inkjet printing, vapor deposition through a mask, laser patterning, or other suitable techniques known in the art.

The gel polymer electrolyte (GPE) film may comprise one or more polymers selected from poly(methyl methacrylate) (PMMA), poly(acrylonitrile), poly(vinyl alcohol), poly(vinyl acetate), poly(vinyl butyrate), polymers soluble in polar organic solvents or solvent mixtures, and copolymers thereof. The polymers may be linear, branched, cross-linked, or non-cross-linked.

The patterned metallic electrode may be disposed on the polymeric film substrate through various methods including printing, adhering, depositing, electroplating, or by pre-forming the electrode on a carrier substrate. The electrode is then integrated with the polymeric film substrate through the calendaring process described herein. In some embodiments, the patterned metallic electrode is pre-formed or pre-fabricated on the polymeric film substrate before calendaring. In other embodiments, the patterned metallic electrode may be initially disposed on a separate carrier substrate and then embedded into the polymeric film substrate during the calendaring step.

As used herein, the term “disposed on” refers to the patterned metallic electrode being adhered, printed, positioned, deposited on, or in contact with the polymeric film substrate, and encompasses both configurations where the electrode is initially placed on the surface of the substrate and subsequently integrated through calendaring, as well as configurations where the electrode is directly embedded during the manufacturing process. The terms such as “disposed on” “embedded in” and “applied to” may all refer to the electrode being in intimate contact with and integrated into the polymeric film substrate such that the electrode and substrate function as a unified structure. During the calendaring process, the application of pressure and heat causes the electrode to become partially or fully embedded into the polymeric film substrate, creating a mechanically stable composite structure.

The electrolyte-electrode stack may further comprise a release liner adjacent to the GPE film. Release liners may be provided on both outer surfaces of the stack, enabling the stack to be wound into a roll configuration for enhanced shelf-life during storage and transport. The release liners may be removed prior to application of the stack to a substrate.

In an alternative embodiment, the electrolyte-electrode stack may further comprise a transparent conducting oxide (TCO) layer in contact with a surface of the GPE film opposite the patterned metallic electrode. The TCO layer may comprise indium tin oxide (ITO), fluorine-doped tin oxide (FTO), aluminum-doped zinc oxide (AZO), or other suitable materials.

In other aspects, the present disclosure provides manufacturing methods for producing the electrolyte-electrode stack. The method may comprise providing a patterned metallic electrode disposed on a polymeric film substrate, applying the patterned metallic electrode on the polymeric film substrate onto a GPE film using a calendaring process, applying a release liner to the GPE film to form a single adherence stack, and optionally removing the release liner and applying the single adherence stack to a TCO layer on a glass or plastic surface.

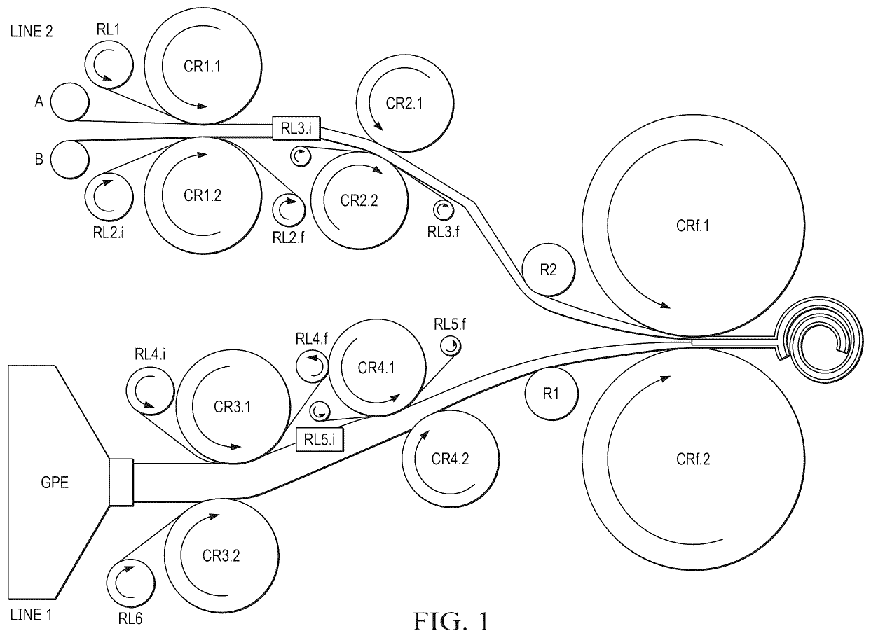

By way of example, FIG. 1 illustrates the exemplary three main stages of the disclosed manufacturing process: Line 1, Line 2, and the Final Product Line. Components referenced in the figure are outlined below:
Line 1: Gel Polymer Electrolyte (GPE) Preparation
   GPE: Gel Polymer Electrolyte
   RL4i, RL4f: Initial and final release liners to prevent adherence to Calendar Roll 3
   RL6: Release liner intended to survive to the end of the product line and storage
   CR3.1, CR3.2: Calendar rolls for initial downsizing of the GPE
   CR4.1, CR4.2: Calendar rolls for final downsizing of the GPE
   RL5i, RL5f: Initial and final release liners to prevent adherence to Calendar Roll 4
Line 2: Patterned Metallic Electrode Embedding
   A: Roll of polymeric film for embedding
   B: Roll of patterned metallic electrode
   RL1: Release liner intended to survive to the end of the product line and storage
   RL2i, RL2f: Initial and final release liners to prevent adherence to Calendar Roll 1
   CR1.1, CR1.2: Nip-calendar rolls for initial alignment of A and B
   CR2.1, CR2.2: Calendar rolls for embedding B into A
   RL3i, RL3f: Initial and final release liners to prevent adherence to Calendar Roll 2
Final Product Line: Assembly of GPE and Embedded Electrode
   R1: Alignment roller to guide Line 1 product to the final calendar roll
   R2: Alignment roller to guide Line 2 product to the final calendar roll
   CRf.1, CRf.2: Final calendar rolls that embed Line 2 product into Line 1 product

An “embedded patterned metal electrode” refers to a metal electrode that is physically integrated within a substrate material, where the metal is arranged in a specific pattern (like lines, grids, or other shapes) to achieve desired electrical conductivity and functionality, often used in flexible electronics where the patterned design helps maintain performance even when the material is bent or stretched. In this disclosure, the embedded patterned metallic electrode laminated onto a GPE film is formed by a tandem series consisting of two pretreatment lines, named Line 1 and Line 2, that aggregate into the final product line (Final Extrusion).

Line 1 includes the extrusion of the GPE to the desired thickness for the intended application, generally 10-20 μm greater to account for final extrusion losses, ranging from 10-10000 μm. The extrusion line may account for a release liner on both sides of the GPE to prevent sticking at the calendar nips while also offering a substrate to maintain a taut line. The calendar rolls may also be heated from 20-150° C. to soften the GPE for improved pliability.

Line 2 includes a pre-roll calendar in line with the patterned metallic electrode and a release liner to apply light pressure required to flatten the patterned metallic electrode against the release liner to ensure even distribution of electrode wires within the taut line. After the patterned metallic electrode is in good contact with the release liner, progression forward to Line 2 where the patterned metallic electrode and release liner may laminate and embed into an optically clear substrate (either rigid or flexible). The process to embed the patterned metallic electrode into the crosslinked polymeric substrate may require higher pressure and temperature at the calendaring roll for more rigid polymeric substrates. Both may require moderately higher pressure which is achieved by adjusting the distance between calendar nips.

With two lines completed, forming the GPE and the patterned metallic electrode/OCA substrates, they are then combined with the GPE contacting the patterned metallic electrode producing the final product, which then leads to a roll to be wound up and sealed under light vacuum. The configuration of Line 1 may comprise two calendar rolls, a GPE feed port, and three release liner feeds all of which are in a series. The GPE feed port and release liner feeds 1 and 2 may be in line with Calendar Roll 1, in order to pre-extrude the GPE to a uniform roughing thickness about 110-120% the intended final thickness of the GPE film. The GPE film continues with Release Liner 1 and Release Liner 2, being removed at a critical angle to not perturb the GPE interface. Release liner surface 2 is up and the surface that may contact the patterned metallic electrode as the film moves towards Calendar Roll 2. Calendar Roll 2 may have Release Liner 3 pulled taut against the top barrel nip of Calendar Roll 2, which has a set thickness ~10-20 μm greater than the final desired product thickness to ensure a proper stepwise extrusion in the final extrusion step. Release Liner 3 may be removed, similar to Release Liner 2, right before the final extrusion step to expose the GPE surface for lamination. The purpose for Release Liner 1 is to act as a packaging release liner to be removed only when building a full RME window. Release Liners 2 and 3 and both extrusion liners prevent sticking at the calendar barrel nips, and specifically there are two to ensure no striation lines in Release Liner 2 impact the final extrusion. The speed of the Calendar Roll may vary from 0.001-80 meters/s depending on the desired thickness. The temperature of the Calendar Rolls during extrusions may vary from 20-200° C. and depend on several factors such as the viscoelastic properties of the GPE, release liner properties, and polymer plus salts plus solvents used in GPE relative temperature stability.

The configuration of Line 2 may comprise two calendar rolls, one release liner feed, one optically clear polymer film to embed the patterned metallic electrode, and a roll of patterned metallic electrode. The release liner and patterned metallic electrode may go through Calendar Roll 1 which is set to a gap thickness ~10 μm greater than the anticipated thickness of the two combined to flatten the patterned metallic electrode across the taut release liner, without harming the release liner. The patterned metallic electrode and release liner continue to Calendar Roll 2, where it comes into contact with the newly exposed polymeric embedding material that is also pulled taut for a smooth interface. The gap thickness for Calendar Roll 2 should be set to 1-10 μm less than the anticipated sum of thicknesses, to ensure that the pressure applied is great enough to embed the patterned metallic electrode into the polymeric embedding material. Calendar Roll 1 is run at room temperature while Calendar Roll 2 may be run at a temperature ~10° C. lower than the softening temperature of the polymeric embedding material and temperature should only be applied to the calendar barrel in contact with the embedding polymeric material to ensure the release liner does not melt. The line should be run at a constant speed that is slow enough to ensure the polymeric embedding material is softened to allow the patterned metallic electrode to embed. This implies that the speed of the complete system may depend on this rate which can be adjusted by altering the temperature of the barrel.

The Final Product Line may comprise one calendar roll, two release liner collectors, and a final product collection dowel. The products of Line 1 and Line 2 may meet at the Final Product Line Calendar Roll. Prior to entering the Calendar Roll, the release liners may be removed from the GPE stack and patterned metallic electrode stack at the interfaces they may contact. After the release liners are removed, the two products may be extruded through the Final Calendar Roll. The total gap thickness should be 10-20 μm less than the expected thickness to ensure the exposed patterned metallic electrode is completely embedded into the GPE. After the GPE is laminated onto the patterned metallic electrode embedded in the polymeric substrate layer, it is then rolled onto the collection dowel after full lamination, with the stack in the order of: Release Liner, Polymeric Embedding Film, Patterned Metallic Electrode, GPE, Release Liner.

In an alternative embodiment of the Product Line, the GPE film is prepared not by a calendar roll but through a twin-screw extractor into a die film caster. This alternative method would preclude the necessity for Roll Calendar Line 1 for preparing the GPE film, or at minimum remove the necessity of the first Calendar Roll for stepping-down the thickness of the GPE. The use of release liners may still be necessary to facilitate release from the final Calendar Roll and for ease of storage after generating the embedded patterned metallic electrode with GPE stack.

The GPE film may comprise a heavily plasticized linear, branched, or crosslinked polymer that is processed at elevated temperature and possesses appropriate viscoelastic properties to provide mechanical stability and adhesive properties to the electrolyte, prevent leaking of low viscosity electrolytes, and support electrodeposition of a conformal metal film. The plasticizer is composed of at least one compatible solvent, active metal salt, supporting salt, UV/oxidative stabilizers, surfactants, and combinations thereof. The polymer and electrolyte plasticizer are combined by mechanical or high shear mixing such as mechanical stirring, tumble mixing, or extrusion. Once combined, nip rolling, calendaring, or pressing form the mixture into a film with the appropriate dimensions for lamination between two electrodes. The GPE polymers include, for example: poly(methyl methacrylate) (PMMA); PMMA copolymers with methacrylic acid, alkyl (meth)acrylates, and hydroxyl containing (meth)acrylates; poly(acrylonitrile); poly((meth)acrylic acid); poly(vinyl alcohol); poly(vinyl acetate); poly(vinyl butyrate) and copolymers thereof; and other polymers soluble in polar organic solvents or solvent mixtures. Commercial sources of PMMA include, for example, Elvacite® 2041, Elvacite® 2051, Elvacite® 2021C, Elvacite®4026, and Elvacite® 4059 from Mitsubishi Chemical. The release liners include, for example: polyester films, polycoated kraft (polyethylene), polyether imide (PEI), high- and low-density polyethylene (H/LDPE), polypropylene (PP), polyester (Mylar®, polyethylene terephthalate (PET)). Optically clear films include, for example, both optically clear adhesives (OCAs) and thermoplastics: PVB, acrylate, silicone thin films, rubber thin films, PET thin films, EVA thin films, TAC thin films, COP thin films and other commercially available OCA and thermoplastic films.

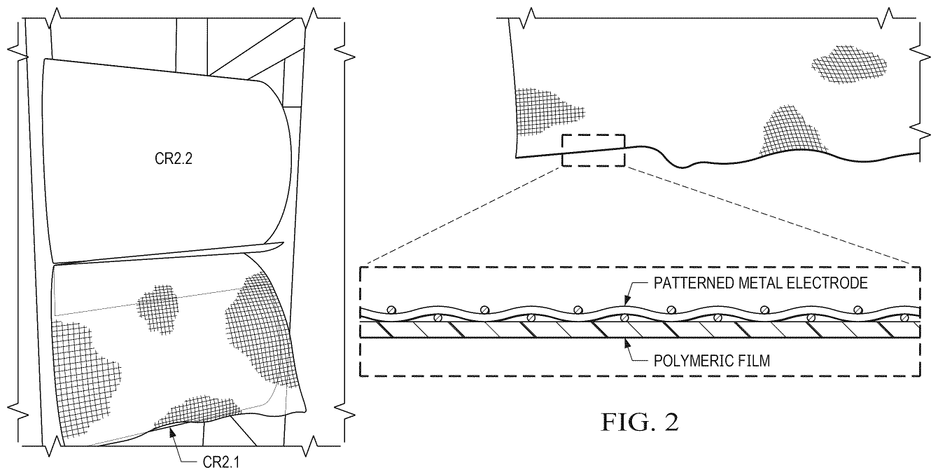

FIG. 2 illustrates an exemplary product of Line 2, with insets zooming in on the embedded patterned metallic electrode in a semi-rigid polymeric film. The figure showcases a semi-rigid polymeric film, which demonstrates that rigid and flexible films of very thin varieties can be candidates for this process.

The foregoing detailed description includes various embodiments of electrolyte-electrode stacks and methods for their manufacture, providing those skilled in the art with sufficient information to practice the present disclosure. Those of skill in the art will recognize that modifications and variations can be made in the specific embodiments disclosed herein without departing from the spirit and scope of the present disclosure. For example, alternative polymer compositions, electrode materials, substrate configurations, and processing parameters may be selected based on specific application requirements while still achieving the advantageous mechanical stability and roll-to-roll processability disclosed herein. Similarly, the calendaring temperatures, pressures, and line speeds may be adjusted within the disclosed ranges to accommodate different material properties and desired film thicknesses. All embodiments of the electrolyte-electrode stacks and manufacturing methods disclosed and claimed herein can be made and executed by a person skilled in the art without undue experimentation in light of the present disclosure. The specific examples, materials lists, processing parameters, and detailed manufacturing descriptions provided herein enable those skilled in the art to understand and practice the full scope of the present disclosure. Appropriate substitutions and modifications apparent to those skilled in the art are deemed to be within the spirit, scope, and concept of the present disclosure as defined by the appended claims.

### EXAMPLES

The following examples are provided to illustrate various embodiments of the present disclosure and are not intended to limit the scope of the disclosure. Those skilled in the art will recognize that modifications and variations can be made without departing from the spirit and scope of the disclosure.

### Example 1: Preparation of Electrolyte-Electrode Stack

A gel polymer electrolyte (GPE) is prepared by dissolving 15 grams of poly(methyl methacrylate) (PMMA) with a molecular weight of approximately 350,000 g/mol in 85 grams of propylene carbonate solvent. To this solution is added 5 grams of zinc trifluoromethanesulfonate (Zn(CF₃SO₃)₂) as the active metal salt and 2 grams of lithium bis(trifluoromethanesulfonyl)imide (LiTFSI) as a supporting salt. The mixture is mechanically stirred at room temperature for 4 hours until a homogeneous gel is obtained. The GPE is then extruded through a slot die onto a release liner (silicone-coated polyethylene terephthalate film) to form a film with a thickness of approximately 200 micrometers. The extruded GPE film is passed through calendar rolls maintained at 40° C. to achieve uniform thickness.

A patterned zinc electrode is prepared by screen printing zinc metal ink in a grid pattern (20 micrometer line width, 500 micrometer spacing) onto a polyvinyl butyral (PVB) film having a thickness of 100 micrometers. The printed electrode is dried at 80° C. for 30 minutes. The zinc electrode on PVB substrate is then flattened against a release liner and fed into a calendaring station together with the GPE film prepared above. The electrode side of the PVB substrate is brought into contact with the GPE surface, and the combined structure is passed through calendar rolls at 60° C. with moderate pressure (approximately 200 psi) to embed the zinc electrode into the GPE and bond the PVB substrate to the GPE. A second release liner is applied to the exposed PVB surface, and the complete stack is wound onto a collection roll.

The resulting electrolyte-electrode stack has a total thickness of approximately 300 micrometers and exhibits an optical transmission of approximately 75% in the visible spectrum. The stack can be handled in roll form without tearing or deformation, demonstrating that the zinc electrode integrated with the PVB substrate provides sufficient mechanical stability to the gel polymer electrolyte for roll-to-roll processing. When a segment of this stack is applied to fluorine-doped tin oxide (FTO) coated glass and operated at ±1.5 volts, the device switches between transparent and darkened states, with visible light transmission decreasing from 75% to approximately 25% within 60 seconds upon voltage application, and returning to the transparent state within 90 seconds upon voltage reversal.

### Example 2: Production Method With Bismuth Oxide Electrode

A gel polymer electrolyte is prepared by dissolving 18 grams of poly(acrylonitrile) (PAN) in 82 grams of a solvent mixture comprising propylene carbonate and gamma-butyrolactone in a 3:1 ratio. To this solution is added 6 grams of bismuth trifluoromethanesulfonate (Bi(CF₃SO₃)₃) as the active metal salt and 1.5 grams of lithium trifluoromethanesulfonate as a supporting salt. The mixture is subjected to high shear mixing for 3 hours to achieve thorough dispersion. The GPE is extruded to a predetermined thickness of 150 micrometers onto a release liner.

A patterned electrode comprising bismuth oxide (Bi₂O₃) is formed by sputtering through a shadow mask onto an optically clear adhesive (OCA) film (acrylate-based, 50 micrometers thick) to create a mesh pattern with 15 micrometer line width and 300 micrometer spacing. The Bi₂O₃ layer has a thickness of approximately 200 nanometers. The Bi₂O₃ electrode on OCA substrate is flattened and then applied onto the GPE film using a calendaring process. The calendaring is performed at 50° C. with pressure of approximately 150 psi. A release liner is applied to the GPE film to form a single adherence stack.

The release liners are removed, and the single adherence stack is applied to a transparent conducting oxide (TCO) layer on a glass surface. The OCA substrate adheres directly to the FTO-coated glass without requiring additional adhesive. The resulting device exhibits an optical transmission of approximately 80% in the transparent state due to the high transparency of the Bi₂O₃ electrode material. When voltage is applied, bismuth metal deposits onto the Bi₂O₃ mesh, creating a highly reflective mirror-like appearance, demonstrating reversible metal electrodeposition functionality.

### Example 3: Method for Improving Mechanical Stability of GPE Film

To demonstrate the mechanical stability improvement provided by integrating a patterned metallic electrode with a gel polymer electrolyte, a comparative study is performed. A GPE film is prepared by dissolving 20 grams of poly(vinyl alcohol) (PVA) in 80 grams of a solvent mixture containing propylene carbonate, ethylene carbonate, and water. The mixture includes 4 grams of copper(II) trifluoromethanesulfonate as the active metal salt. The GPE is cast onto a release liner to a thickness of 200 micrometers.

When an attempt is made to wind this GPE film alone (without integrated electrode) onto a roll, the unsupported GPE film deforms significantly under mechanical stress, resulting in thickness variations, wrinkling, and tearing. The material cannot be successfully processed in roll form. However, when a patterned copper electrode disposed on a polyethylene terephthalate (PET) film is provided and applied onto the GPE film using a calendaring process at 45° C. and 180 psi, the resulting structure exhibits sufficient mechanical integrity. The GPE film is then laminated with a release liner to complete the stack.

The resulting electrolyte-electrode stack can be readily wound, unwound, and rewound multiple times without deformation or tearing. The stack maintains uniform thickness and structural integrity throughout handling and processing. This comparison clearly demonstrates that the patterned metallic electrode disposed on the polymeric film substrate provides essential mechanical reinforcement to the gel polymer electrolyte, enabling roll-to-roll manufacturing that would otherwise be impractical with unsupported GPE materials.

### Example 4: GPE Preparation by Mechanical Mixing With Electrolyte Plasticizer

A gel polymer electrolyte is prepared by mechanical mixing of a polymer and an electrolyte plasticizer. The polymer comprises 25 grams of poly(methyl methacrylate) (PMMA) that is linear and non-cross-linked, with a molecular weight of 250,000 g/mol. The electrolyte plasticizer comprises: 70 grams of propylene carbonate (compatible solvent), 5 grams of zinc trifluoromethanesulfonate (active metal salt providing zinc ions for reversible electrodeposition), 2 grams of tetrabutylammonium perchlorate (supporting salt to enhance ionic conductivity), 0.8 grams of 2-(2H-benzotriazol-2-yl)-4,6-ditertpentylphenol (UV/oxidative stabilizer to protect against degradation), and 0.5 grams of polyoxyethylene sorbitan monooleate (surfactant to improve wetting and interfacial contact).

The polymer and electrolyte plasticizer are combined and subjected to mechanical stirring at 500 rpm for 5 hours at room temperature. The mixture is then processed through a twin-screw extruder operated at 90° C. for additional homogenization. The resulting GPE is extruded to 180 micrometer thickness. A patterned silver electrode disposed on a polycarbonate (PC) film is provided and applied onto the GPE film using a calendaring process. The calendaring process comprises heating the GPE film to 70° C. to enhance pliability, and applying the patterned electrode with pressure of 220 psi. The GPE film is laminated with release liners on both surfaces.

The release liners are subsequently removed, and the electrolyte-electrode stack is applied to a TCO layer on a plastic surface (polycarbonate substrate coated with indium tin oxide). The device operates effectively for dynamic reversible metal electrodeposition applications, with silver metal depositing and dissolving reversibly upon voltage application. The device exhibits switching times of approximately 35 seconds for coloring and 50 seconds for bleaching, demonstrating the utility of the disclosed GPE preparation method.

Taken together, these examples demonstrate successful implementation of the disclosed compositions and methods to create mechanically stable electrolyte-electrode stacks suitable for roll-to-roll manufacturing. The examples illustrate the versatility of the approach across different polymer types, electrode materials, and substrate configurations, and establish that the disclosed technology provides practical solutions for manufacturing gel polymer electrolyte based electrochemical devices at commercial scales.

What is claimed is:

1. An electrolyte-electrode stack, comprising:
a polymeric film substrate;
a patterned metallic electrode disposed on the polymeric film substrate; and
a gel polymer electrolyte (GPE) film in contact with the patterned metallic electrode.

2. The electrolyte-electrode stack of claim 1, further comprising a release liner adjacent to the GPE film.

3. The electrolyte-electrode stack of claim 1, wherein the stack is produced from a roll-to-roll (R2R) manufacturing process.

4. The electrolyte-electrode stack of claim 1, wherein the polymeric film substrate comprises one or more materials selected from the group consisting of polyvinyl butyral (PVB), acrylate polymer, silicone, rubber, polyethylene terephthalate (PET), ethylene-vinyl acetate (EVA), triacetate cellulose (TAC), cyclic olefin polymer (COP), polycarbonate (PC), and optically clear adhesive (OCA).

5. The electrolyte-electrode stack of claim 1, wherein the polymeric film substrate is capable of adhering to a glass or plastic surface.

6. The electrolyte-electrode stack of claim 1, wherein the patterned metallic electrode comprises one or more metals selected from the group consisting of bismuth, zinc, copper, aluminum, silver, gold, nickel, and oxides thereof.

7. The electrolyte-electrode stack of claim 1, wherein the patterned metallic electrode is configured to enable reversible metal electrodeposition (RME).

8. The electrolyte-electrode stack of claim 1, wherein the GPE film comprises one or more polymers selected from the group consisting of poly(methyl methacrylate) (PMMA), poly(acrylonitrile), poly(vinyl alcohol), poly(vinyl acetate), poly(vinyl butyrate), polymers soluble in polar organic solvents or solvent mixtures, and copolymers thereof; wherein the one or more polymers are linear, branched, cross-linked, or non-cross-linked.

9. The electrolyte-electrode stack of claim 1, further comprising a transparent conducting oxide (TCO) layer in contact with a surface of the GPE film opposite the patterned metallic electrode.

10. A method for producing an electrolyte-electrode stack, the method comprising:
providing a patterned metallic electrode disposed on a polymeric film substrate;
applying the patterned metallic electrode on the polymeric film substrate onto a gel polymer electrolyte (GPE) film using a calendaring process;
applying a release liner to the GPE film to form a single adherence stack; and
optionally removing the release liner and applying the single adherence stack to a transparent conducting oxide (TCO) layer on a glass or plastic surface.

11. The method of claim 10, wherein the calendaring process comprises:
extruding the GPE film to a predetermined thickness;
flattening the patterned metallic electrode on the polymeric film; and
applying the patterned metallic electrode on the polymeric film substrate onto the GPE film by applying pressure and heat.

12. The method of claim 10, wherein the polymeric film substrate comprises one or more materials selected from the group consisting of polyvinyl butyral (PVB), acrylate polymers, silicone, rubber, polyethylene terephthalate (PET), ethylene-vinyl acetate (EVA), triacetate cellulose (TAC), cyclic olefin polymer (COP), polycarbonate (PC), and optically clear adhesive (OCA).

13. A method for improving the mechanical stability of a gel polymer electrolyte (GPE) film, the method comprising:
providing a patterned metallic electrode disposed on a polymeric film substrate;
applying the patterned metallic electrode on the polymeric film substrate onto the GPE film using a calendaring process; and
laminating the GPE film with a release liner.

14. The method of claim 13, wherein the calendaring process comprises heating the GPE film to a temperature between 20° C. and 150° C. to enhance pliability.

15. The method of claim 13, wherein the patterned metallic electrode on the polymeric film substrate is flattened against a release liner before applying to the GPE film.

16. The method of claim 13, further comprising applying the laminated GPE film to a transparent conducting oxide (TCO) layer on a glass or plastic surface.

17. A method for producing an electrolyte-electrode stack, the method comprising:
preparing a gel polymer electrolyte (GPE) film by mechanical or high shear mixing of a polymer and an electrolyte plasticizer;
providing a patterned metallic electrode disposed on a polymeric film substrate;
applying the patterned metallic electrode on the polymeric film substrate onto the GPE film using a calendaring process; and
laminating the GPE film with a release liner.

18. The method of claim 17, wherein the polymer is selected from the group consisting of poly(methyl methacrylate) (PMMA), poly(acrylonitrile), poly(vinyl alcohol), poly(vinyl acetate), poly(vinyl butyrate), a polymer soluble in polar organic solvent or solvent mixture, a copolymer thereof, and any combination thereof; wherein the polymer is linear, branched, cross-linked, or non-cross-linked.

19. The method of claim 17, wherein the electrolyte plasticizer comprises a compatible solvent, an active metal salt, a supporting salt, a UV/oxidative stabilizer, and/or a surfactant.

20. The method of claim 17, further comprising removing the release liner and applying the electrolyte-electrode stack to a transparent conducting oxide (TCO) layer on a glass or plastic surface for use in dynamic reversible metal electrodeposition (RME) applications.
